(19) United States
(12) Patent Application Publication
(10) Pub. No.: US 2003/0146324 A1
(43) Pub. Date: Aug. 7, 2003

(54) Fishing reel with a replaceable casing

(76) Inventor: Shih-Yuan Yeh, Tai-Ping City (TW)

Correspondence Address: Jones, Tullar & Cooper, P.C., Suite 1002, 2001 Jefferson Davis Highway, Arlington, VA, 22202, US

(21) Appl. No.: 10/066,683

(22) Filed: Feb. 6, 2002

(51) Int. Cl. A01K 89/01; A01K 89/00

(52) U.S. Cl. 242/311; 43/20

(57) ABSTRACT

A fishing reel has a body, a rotor and a body casing. The body casing is detachably attached to the outer surface of the body and has two body casing halves. The body casing halves are respectively attached by bolts to two sides of the body. Each body casing half has an axle hole for the axle of the crank penetrating through the both axle holes. Accordingly, a user can conveniently change the appearance of the fishing reel by means of fitting one of different casings of assorted shapes or colors.

### BACKGROUND OF THE INVENTION

1. Field of the Invention

The present invention relates to a fishing reel, and more particularly to a fishing reel with a replaceable casing, wherein a user can conveniently replace the casing.

2. Description of Related Art

With reference to FIG. 3, a conventional fixed spool fishing reel (30) in accordance with the prior art comprises a body, a rotor (36) with a bale arm, a spool (37) and a crank (38). A mounting leg (32) is formed on the top of the body, such that the fishing reel (30) is attached to a fishing rod with the mounting leg (32). The rotor (36) is rotatably attached to the body for the fishing line to be wound around the spool (37). A transmission mechanism (not shown) is mounted in the body to actuate the rotor (36) to rotate and the spool (37) to move relative to the body simultaneously. A cover (34) is secured to the body to enclose the internal structure in the body. The crank (38) has an axle extending through the body and connected with the transmission mechanism. Consequently, the user can rotate the rotor (36) by means of turning the crank (38) with the operation of the transmission mechanism. This fixed spool reel improves casting and retrieval of a line wound around the spool (37) in comparison to the center pin fishing reel.

Appreciation of design and style extends into every aspect of modern life and interchangeability of covers (34), such as in mobile phones where a user can easily change from day to day the appearance of a phone, has become a popular trend. Furthermore, anglers may need to consider the appearance of tackle in relation to a particular environment and so different camouflages may be needed to avoid alerting fish to their imminent demise. However, the conventional fixed spool reel has an appearance that cannot be changed and so is not satisfactory to meet modern market demands.

Thus, there is a long and unfulfilled need for a fishing reel with a replaceable casing.

To overcome the shortcomings, the present invention tends to provide a fishing reel to mitigate or obviate the aforementioned problems.

### SUMMARY OF THE INVENTION

The main objective of the invention is to provide a fishing reel with a replaceable casing for a user to conveniently change the appearance of the fishing reel. The fishing reel has a body, a rotor and a body casing. The body casing is detachably attached to the outer surface the body and has two body casing halves. The body casing halves are respectively attached by bolts to two sides of the body. Each body casing half has an axle hole for the axle of the crank to extend therethrough. With such a fishing reel, the user can change the appearance of the fishing reel by means of replacing a casing with a different shape or color.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a fishing reel in accordance with the present invention;

FIG. 2 is a perspective view of the fishing reel in FIG. 1; and

FIG. 3 is a perspective view of a conventional fishing reel in accordance with the prior art.

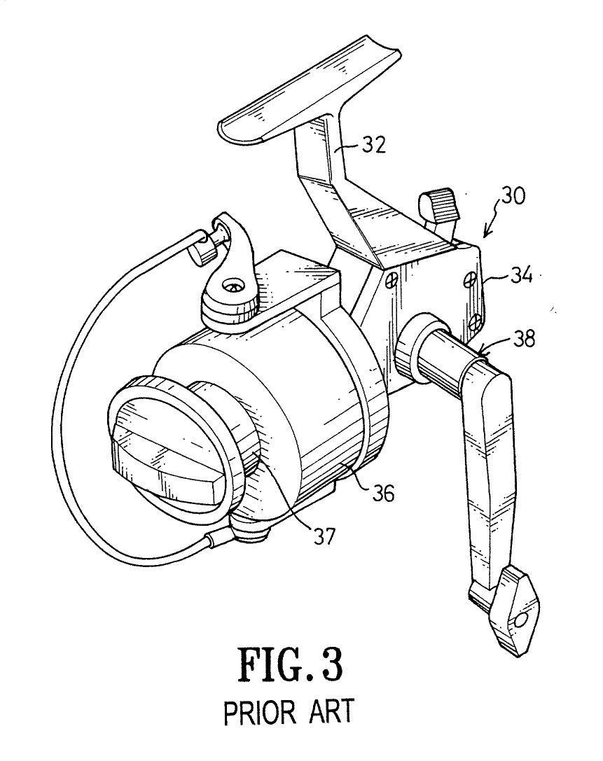

### DETAILED DESCRIPTION OF PREFERRED EMBODIMENT

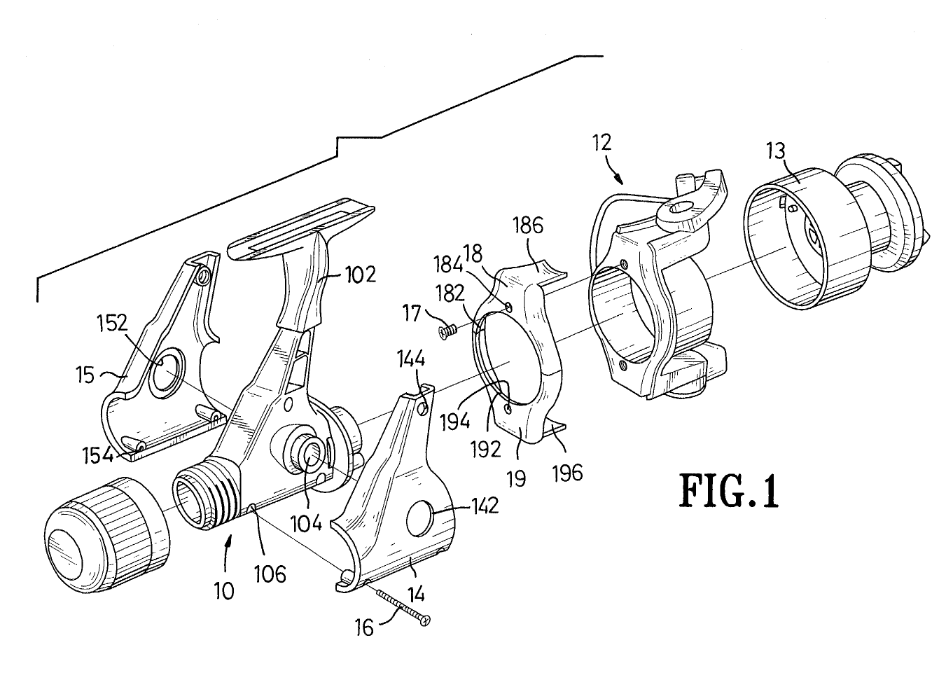

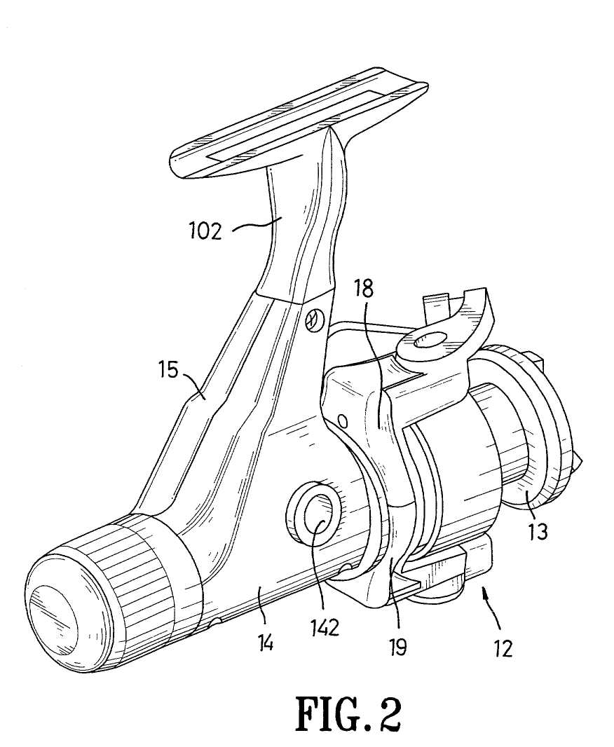

With reference to FIGS. 1 and 2, a fishing reel in accordance with the present invention comprises a body (10), a rotor (12) with a bale arm and a body casing. A mounted leg (102) is formed on the top of the body (10) to connect the body (10) to a fishing rod (not shown). The rotor (12) is rotatably attached to one end of the body (10) for the fishing line wound around a spool (13). A transmission mechanism (not shown) is mounted in the body (10) to actuate the rotor (12) to rotate and reciprocally move the spool relative to the body (10) simultaneously. A crank (not shown) is rotatably attached to the body (10) and has an axle penetrating an axle hole (104) in the body (10) and connected to the transmission mechanism. Consequently, when the crank is rotated, the rotor (12) will simultaneously rotate and reciprocally move the spool (13) relative to the body (10) to retrieve the cast fishing line. It is to be noted that the body (10) may have axle holes (104) on both sides of the body (10) such that the crank can be attached to either side of the body to suit both left handed and right handed anglers. The body casing is detachably attached to the outer surface the body (10) to show a specific appearance. The body casing comprises a first body casing half (14) and a second body casing half (15). The body casing halves (14,15) are respectively attached to two sides of the body (10). Each body casing half (14,15) has an axle hole (142,152), and the axle of the crank penetrates the axle holes (142,152) in both of the body casing halves (14,15). Multiple bores (144) are defined in the first body casing half (14), and a threaded hole (154) is defined in the second body casing half (15) and corresponds to each respective bore (144) in the first body casing (14). A through hole (106) is defined through the body (10) to align with each respective bore (144) in the first body casing half (14) and the corresponding one of the threaded holes (154) in the second body casing half (15). Bolts (16) respectively extend through the bores (144) in the body casing half (14) and corresponding through holes (106) in the body (10) and are screwed into the corresponding threaded holes (154) in the second body casing half (15). Accordingly, the body casing halves (14,15) are detachably attached to the body (10) so as to provide a specific appearance by the body casing.

A rotor casing is detachably to the outer surface of the rotor (12). The rotor casing comprises two rotor casing halves (18,19). Each rotor casing half (18,19) is arcuate and has a half-round recess (182,192) defined in the side of the rotor casing half (18,19) at the one end adjacent to the other rotor casing half (1 8,19). A bore (184,194) is defined in each respective rotor casing half (18,19). A screw (17) penetrates the bore (184,194) in each respective rotor casing half (18,19) and is screwed into the rotor (12). Consequently, the rotor casing halves (18,19) are detachably attached to the rotor (12) at the side facing the body (10). In addition, an ear (186,196) vertically extends from one end of each respective rotor casing half (18,19) far from the other half (18,19) to abut a side of the rotor (12). With the rotor casing, the appearance of the fishing reel is changeable and can meet demands of style and fishing environments.

With such a fishing reel, because the body casing and the rotor casing are respectively attached to the body (10) and rotor (12) with bolts (16) and screws (17), the body casing and the rotor casing can easily be removed from the body (10) and the rotor (12) by means of unscrewing the bolts (16) and the screws (17). Therefore, if the user wants to use a fishing reel with a different appearance, the user just only need change a body casing and/or a rotor casing with a different shape or color and not buy a new one. Thus the cost for using a fishing reel with a different appearances is low. In addition, because a half-round recess (182,192) is defined in each respective rotor casing half (18,19), a round hole is defined between the two rotor casing halves (18,19) to receive a conjunction between the body (10) and the rotor (12). Accordingly, to disassemble the rotor (12) from the body (10) is not needed when the rotor casing is replaced, whereby to change the rotor casing is very convenient to a normal user and thus the use of the fishing reel is more versatile than the prior art.

For a manufacturer, to meet the different demands of customers, the manufacturer just only needs to make one type of the body (10) and the rotor (12) and multiple types of body casings and rotor casings. The customer can change the appearance of the fishing reel without special tools or skill and have a fishing reel suitable to the environment or current style. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fishing reel comprising:
a body having a mounted leg formed on a top of the body, a transmission mechanism mounted in the body, a spool reciprocally driven by the transmission mechanism and mounted on the body, and a crank with an axle penetrating the body to actuate the transmission mechanism to operate;
a rotor mounted around the spool and rotatably attached to the body and actuated by the transmission mechanism;
and
a body casing detachably attached to an outer surface the body and comprising:
a first body casing half and a second body casing half respectively attached to two sides of the body, each body casing half having an axle hole for the axle of the crank penetrating through the axle holes in both of the body casing halves; and
multiple bolts extending through the first body casing half and the body and screwed with the second body casing half.

2. The fishing reel as claimed in claim 1 further comprising a rotor casing detachably to an outer surface of the rotor and comprising:
two arcuate rotor casing halves attached to the rotor at a side facing the body, each rotor casing half having a half-round recess defined in one end of the rotor casing half adjacent to the other rotor casing half; and
a screw extending each respective rotor casing half and screwed into the rotor to detachably attach the corresponding one of the rotor casing halves to the rotor.

3. The fishing reel as claimed in claim 2, wherein each rotor casing half has an ear vertically extending from one end of the rotor casing half far from the other rotor casing half to abut a side of the rotor.

4. The fishing reel as claimed in claim 2 further comprising:
multiple bores defined in the first body casing half;
a threaded hole defined in the second body casing half and corresponding to each respective bore in the first body casing;
a through hole defined through the body to align with each respective bore in the first body casing half and the corresponding one of the threaded holes in the second body casing half,
wherein the bolts respectively extend through the bores in the first body casing half and the corresponding through holes in the body and are screwed into the corresponding threaded holes in the second body casing half.
